(19) United States
(12) Patent Application Publication
(10) Pub. No.: US 2012/0311285 A1
(43) Pub. Date: Dec. 6, 2012

(54) Method and System for Context Specific Hardware Memory Access Protection

(76) Inventor: Ronald Dean Smith, Phoenix, AZ (US)

(21) Appl. No.: 13/249,246

(22) Filed: Sep. 30, 2011

Related U.S. Application Data
(60) Provisional application No. 61/493,157, filed on Jun. 3, 2011.

(51) Int. Cl. G06F 12/14

(52) U.S. Cl. 711/163; 711/E12.093

(57) ABSTRACT

Methods and systems are provided that provide a hardware based memory access protection system which may prevent access to secret data due to either accidental hardware or software failure, or inappropriate access via a system attack. This system includes a memory protection module and divides global memory space into two classes—a “highly protected region” and an “other” region. In some implementations, the system may be entirety located on hardware on a system chip, making unauthorized manipulation difficult. In some implementations, this system may allow a user to pre-program every allowable operation which may be performed by any given bus master, not only the allowable operations of a processor. Register pairs are used to control access to protected regions of memory by masters on the bus.

### RELATED APPLICATION

The present application claims benefit to U.S. Provisional Patent Application Ser. No. 61/493,157 filed Jun. 3, 2011, entitled “Method and System for Context Specific Hardware Memory Access Protection,” which is incorporated by reference herein.

### FIELD OF THE INVENTION

This generally relates to memory protection and more particularly to a hardware memory protection module.

### BACKGROUND

In the modem computing and information technology (“IT”) environment, security is often paramount. Conventional system architectures place masters and slaves on a shared interconnect bus. A master may be any logical device on the bus which can initiate an operation (such as a read or a write). A slave is a logical device on the bus which responds to these requests. A given logical device may possibly take on both roles. An example master would be a processor attached to the bus. Another example master would be a DMA controller, either as a standalone system resource or as a resource dedicated to a specific function such as a USB controller. Conventional processor architectures often implement a memory translation and protection scheme which does not extend across all master devices on the system, but is restricted to the processor only.

Secret data is stored by a broad class of computer users, from large companies down to individual users of personal computers. There are two basic types of secret data which occur in computing systems, “plaintext” data and “ciphertext” data. Plaintext data is any data stream which comprises secret data which the user wishes to keep secret from unauthorized viewers and which has not previously been encrypted. Ciphertext data on the other hand, is currently encrypted and exposure is less detrimental to a user who wishes to keep this data secret. Security of the plaintext data, however, involves assurance that the plaintext data cannot be misappropriated, nor can it mix with the ciphertext data by crossing the system boundaries between plaintext and ciphertext data.

Conventional processor architectures support memory translation involving a program running in a virtual address space, with multiple programs appearing to run in the same virtual address space. The processor's memory translation tables, however, map the virtual address to the system's physical memory. This offers protection from one application being enabled to access the data of another application without specific authorization, and also protects against an application interfering with the system software.

Further, conventional processors typically use memory translation schemes which define a translation table wherein each entry corresponds to a fixed size of memory at a specific virtual address. The contents of the memory are conventionally an address translation and protection flags defining the types of allowed access. Translation exceptions are used to guard against one application interfering with another application's physical space, for example the aforementioned crossing of system boundaries by certain data, and against inappropriate access, such as “hacking” the system.

Conventional memory translation schemes such as those described above do not fully protect against erroneous hardware operations nor determined and skilled “hackers” attempting to circumvent the protection and gain access to secret data. Further, these conventional systems do not prevent the unauthorized access in the event of a hardware or software failure.

For example, one conventional “hacking” method is a buffer overflow attack. This is an anomaly wherein a program, while writing data to a buffer, overruns the buffer's boundary and overwrites adjacent memory. This is a special case of violation of memory safety. Buffer overflows can be triggered by inputs that are designed to execute code or alter the way the program operates. This may result in erratic program behavior, including memory access errors, incorrect results, a crash, or a breach of system security Buffer overflow attacks are thus the basis of many software vulnerabilities and can be maliciously exploited. Programming languages commonly associated with buffer overflows include C and C++, which provide no built-in protection against accessing or overwriting data in any part of memory and do not automatically check that data written to an array (the built-in buffer type) is within the boundaries of that array.

Accordingly, there is a desire for a memory access protection system which overcomes these and other related problems.

### SUMMARY

In accordance with the present invention, a method is provided in a data processing system for determining access to grains of memory, comprising programming hardware registers with rules to implement access to one or more grains of memory space by one or more masters on a bus. The method further comprises receiving a request by one of the masters on the bus to access one or more of the grains of memory space, and accessing the programmed hardware registers to determine access to the one or more grains of memory space by the requesting master. The method also comprises determining, by the hardware registers, access to the one or more grains; and providing access to the one or more grains of memory space to the requesting master on the bus.

In one implementation, a data processing system is provided for determining access to grains of memory, comprising a memory space comprising the grains of memory, and a bus connected to hardware registers and masters. The data processing system further comprises one or more masters on the bus configured to request access to one or more of the grains of memory space, and access programmed hardware registers to determine access to the one or more grains of memory space by the requesting master. The data processing system also comprises the hardware registers configured to be programmed with rules to implement access to the one or more grains of memory space by the one or more masters on a bus, and receive a request by one of the masters on the bus to access one or more of the grains of memory space. The hardware registers are further configured to determine access to the one or more grains, and provide access to the one or more grains of memory space to the requesting master on the bus.

### BRIEF DESCRIPTION OF THE DRAWINGS

FIG. 1 illustrates an exemplary embodiment of a hardware based memory access protection system made in accordance with methods and systems consistent with the present invention.

FIG. 2 illustrates an exemplary embodiment of a pair of hardware registers made in accordance with methods and systems consistent with the present invention.

FIG. 3 depicts steps in a method of implementation and use of an exemplary embodiment of a hardware based memory access protection system made in accordance with methods and systems consistent with the present invention.

### DETAILED DESCRIPTION

Methods and systems in accordance with the present invention provide a hardware based memory access protection system which may prevent access to secret data due to either accidental hardware or software failure, or inappropriate access via a system attack. This system includes a memory protection module and divides global memory space into two classes—“highly protected region” and an “other” region. The highly protected region is the area of memory where it would be possible in principal for plaintext and ciphertext data to cross or co-mingle. The highly protected region is where the plaintext data (unencrypted secret data) will flow through and be visible. It is not important that the normal operation of the system would prevent this co-mingling because this protection scheme is intended to provide redundant protection in the presence of one or more fault conditions. In some implementations, the system may be entirely located on hardware on a system chip, making unauthorized manipulation difficult. In some implementations, this system may allow a user to pre-program every allowable operation which may be performed by any given bus master, not only the allowable operations of a processor. In some implementations, these pre-programmed instructions may be locked in, such that subsequent programming attempts are blocked.

Protection against tampering may be achieved, for example, by containing the hardware based memory access protection system within a single application specific integrated circuit (“ASIC”) or field programmable gate array (“FPGA”), or at least that part of the system which has electronic visibility to secret unencrypted data. Since both encrypted data and secret data use similar resources, the system may prevent co-mingling of this data, whether caused by an intentional attack or by accidental and/or deliberately induced failure modes. As part of the mechanism whereby data transfer is affected in this example system, the USB will perform direct memory access (“DMA”) operations between the USB interface and memory buffers. Secret data may be restricted to transfer into the highly protected memory. Data being read or written to the flash memory, likewise, uses a DMA to move data between the actual flash and the memory buffers. This memory protection unit allows for the design of a relatively simple and straightforward system which still provides the necessary enforcement of data isolation between the objects residing on the memory bus.

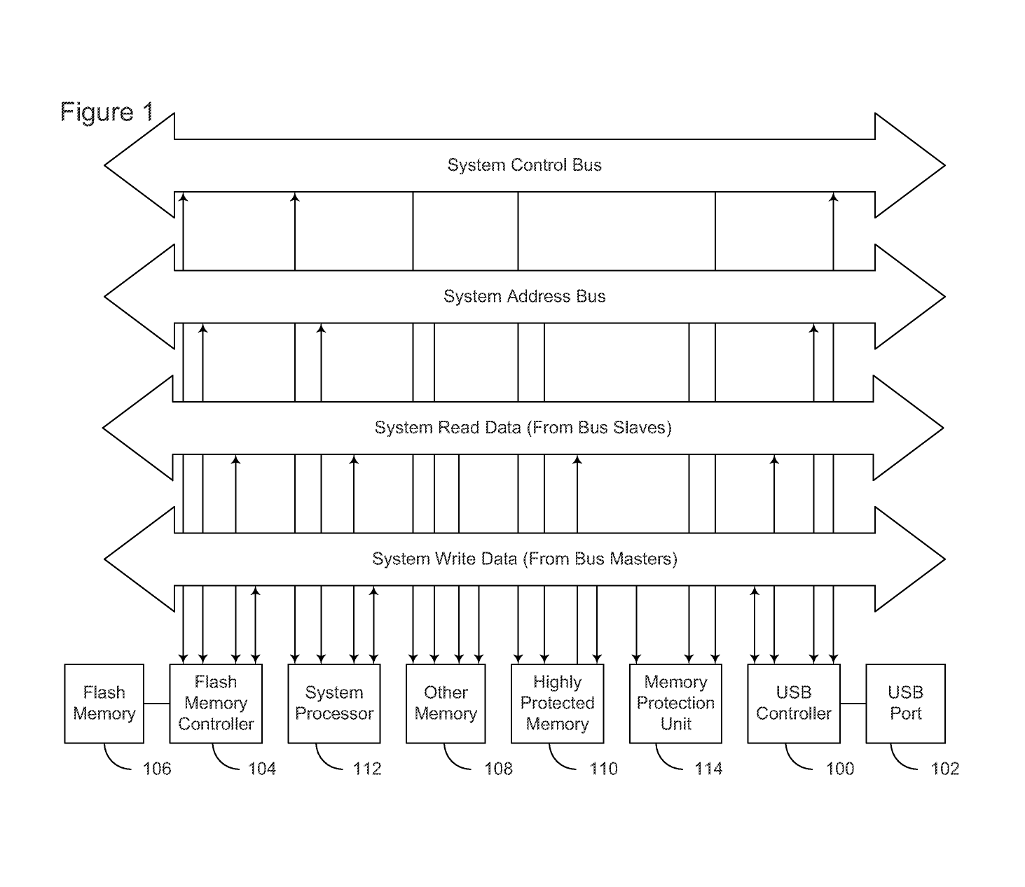

FIG. 1 illustrates an exemplary embodiment of a hardware based memory access protection system made in accordance with methods and systems consistent with the present invention. It should be understood that the specific application diagrammed is provided by way of example only, one of ordinary skill in the art will understand that other exemplary embodiments are possible. The embodiment described occurs within the environment of an otherwise conventional USB mass storage device comprising USB Controller 100 to interface to the USB Port 102 of a computing device, for example a personal computer. The USB mass storage device further comprises a Flash Memory Controller 104 to interface to a Flash Memory 106, as well as the necessary internal connections, processor and bus architecture to implement a USB mass storage device in accordance with USB standards. Large, double-headed arrows are labeled and represent the System Control Bus, System Address Bus, System Read Data, and System Write Data, Further, in FIG. 1, small vertically oriented arrows represent connections between the logical units of the system and the system control bus. The directional heads of these arrows indicate potential directions of data transfer across these connections.

Secret data flows to and from the mass storage device across the USB interface. USB Controller 100 may have a DMA controller incorporated into its logic, allowing the data contained in the USB packets to be moved to and from the internal memory, which is comprised of Other Memory 108 and Highly Protected Memory 110, The internal processing encrypts and decrypts the data and may store or retrieve it from the Flash Memory 106, Flash Memory 106 provides long term storage of the data in an encrypted state. If physical access to the USB mass storage system were accomplished, the secret data would still be inaccessible without entry of any necessary access information; for example password(s), decryption key(s), fingerprint scan(s), or other appropriate access controlling systems.

The USB mass storage system may be inserted into the target computing device, Authentication; for example password protection, biometrics, or other security protection; may be performed both on the target computing device and for access to the mass storage device. Secret data is transferred to the USB mass storage device and encrypted by the System Processor 112. The encrypted data is written to the Flash Memory 106. The USB mass storage device may then be removed from the target computing device and reattached later to either the same target computing device or to a different target. Again, authentication may be performed by Memory Protection Unit 112 on both the target and for access to the mass storage device. Encrypted data may be retrieved from the Flash Memory 106, decrypted by the System Processor 108, and the secret data then sent to the target over the system's USB interface.

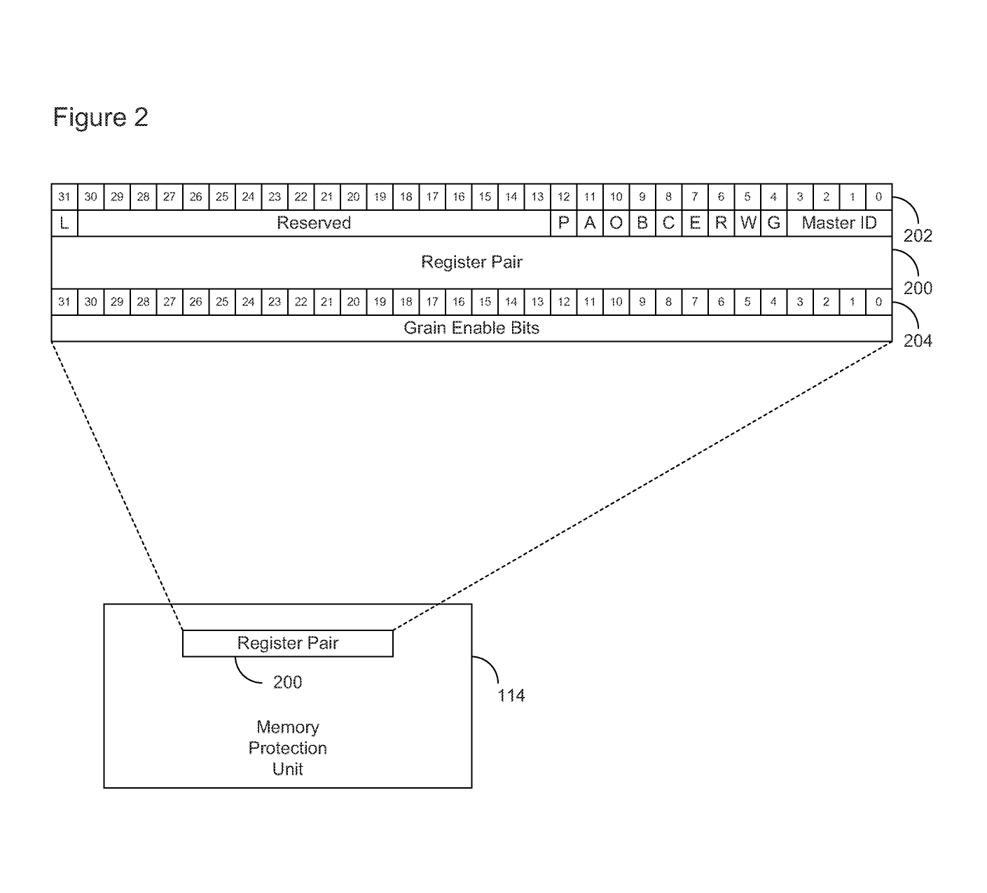

FIG. 2 illustrates an exemplary embodiment of a pair of hardware registers made in accordance with methods and systems consistent with the present invention. Register Pair 200 is on Memory Protection Unit 114. Register Pair 200 is herein shown as a pair of 32 hit registers by way of example only. One of ordinary skill will understand that register pairs in accordance with methods and systems consistent with the present invention may be of any suitable size.

Control Register 202 describes the context of the system bus operation which may be allowed or prevented. The Master ID, as shown in bits 0-3 of Control Register 202, defines which device on the bus is controlled by Control Register 202. The address on the bus defines where in the system the operation is being performed; in the other memory, for example Other Memory 108 of FIG. 1, or in the highly protected memory, for example Highly Protected Memory 110 of FIG. 1. If the address is within the highly protected memory, the address defines which grain in that memory the operation is referring to. The bits in Control Register 202 are used to control the context in which the given master may access, or be denied access to, the specified address.

In Control Register 202, bit 4 is labeled “G.” This signifies that bit 4 determines whether or not Grain Enable Bit Register 204 is to be matched against the system address on the bus or if the system address on the bus is to be matched in the other memory. For example, if the “G” bit is false, the rule context refers to the other memory space and Grain Enable Bit Register 204 has no meaning. If the system address is to the highly protected memory space, then the rule does not apply. If the system address is to the other memory space, the rule applies. On the other hand, if the “G” bit is true, the rule context refers to the highly protected memory and the grain enable bit register defines which grain(s) the rule applies to, if the system address is to the other memory space, the rule does not apply. If the system address is to the highly protected memory space, the rule applies to those addresses where the grain enable bits are set. Control Register 202, bits 5, 6, 7, 8, 9, 10, 11, and 12 are labeled with various letters corresponding to potential rules which may be implemented in exemplary embodiments of methods and systems consistent with the present invention. These rules describe the context of the bus operation, i.e., what the master is attempting to do and how. For example, bit 5 is labeled “W,” signifying a “write.” Bit 6 is labeled “R,” signifying a “read.” Bit 7 is labeled “E,” signifying an “execution,” i.e., a master will be using the data at the specified address as an instruction rather than a data value. Bit 8 is labeled “C,” signifying that the access is “cacheable,” meaning the requesting master may keep a permanent copy of the memory addresses accessed. Bit 9 is labeled “B,” signifying that the access is “bufferable,” meaning the requesting master may keep a transient copy of the memory addresses being accessed for the purposes of optimizing the performance of the memory access. In some implementations, some or all of these rules; along with, in some implementations, any other appropriate rules which may be defined by the user and/or pre-programmed onto the system; may be programmed alone or in any combination to control what operations the controlled bus master may perform for any given bus operation. For example, some implementations may support the bus context of whether the bus operation is being performed in a system context, for example a privileged or operating system, or in a user context, for example an application.

Further, in some implementations, Control Register 202 may also be programmed with conditions instructing the bus master whether, and to what extent, it may perform the programmed rules. For example, in Control Register 202, bit 10 is labeled “O” signifying that the programmed rules are the “Only” operations that the specified master can perform on the grain addresses specified by Grain Enable Bit Register 204. The “Only” condition is applied to each register pair—if any register pair violates an “Only” condition, the system may disallow the operation and generate a fault. The “Only” condition is highly restrictive and generally only one register pair will be dedicated to an only condition. An example of an “Only” rule would be that a given master would be allowed to access “Only” the other memory, any access to the highly restricted memory is disallowed. Another example shown in FIG. 2 is bit 11 of Control Register 202, labeled “A” signifying that the programmed rules specify “Allowed” operations if no allowed operation is being performed by the specified master, the system may disallow the operation and generate a fault. The allowed conditions are applied across all register pairs that specify the same bus master. In some implementations, if one or more register pairs for a specified master is programmed “A,” an operation is allowed if one of the register pairs for that specified master signals a match—the address matches the “G” bit and Grain Enable Register 204, the master ID matches the master ID of Control Register 202, and the context bits allow the operation. A further example shown in FIG. 2 is bit 12 of Control Register 202, labeled “P” signifying the programmed rules specify “Prevented” operations—the system bus operation may be performed on any grains specified, by any bus master specified, unless a prevented condition applies to the given grain or other memory region. Unlike the rules, these “O”, “A” and “P” conditions are mutually exclusive—if a register pair is programmed “Only,” it may not also be programmed “Allowed” or “Prevented.”

For example, in the example of FIG. 2, Control Register 202 comprises 32 bits. Bits number 0, 1, 2; and 3 may be programmed to identify which bus master Control Register 202 controls. In other implementations, the number of bits programmed to identify the controlled bus master may be a number other than four. The number of masters may determine how many bits are used in the master ID. In some implementations, the master 11) need not be contained in the first bits. Grain Enable Bit Register 204 also comprises 32 bits in the example of FIG. 2. Grain Enable Bit Register 204 defines the specific grains of memory to which the set of rules for the given bus master; as specified by Control Register 202, apply. In some implementations, each programmed bit may define a single grain to which the rules apply. In some implementations the bits in Grain Enable Bit Register 204 are in address order, with the least significant bit (“LSB”) farthest to the right and the bits increasing in significance from right to left, culminating in the most significant bit (“MSB”) farthest to the left, Grain Enable Bit Register 204 may comprise as many bits and/or register locations as necessary to cover the total number of grains in the highly restricted memory.

Control Register 202 bits 13-30 are labeled “Reserved,” specifying that these bits are not currently programmed to specify any rules for the specified bus master in relation to the specified grains. In some implementations, Control Register 202 may not contain any reserved bits, all its bits may be programmed. In some implementations, the reserved bits may be programmed at a later time, before Register Pair 200 is “Locked” as described below. Once Register Pair 200 is “Locked,” these bits, like other bits in Register Pair 200, may not allow writing.

Finally, Control Register 202 bit 31 is programmed “L,” signifying that the set of rules, bus master, and affected grains specified within Register Pair 200 have been “Locked.” In this way, the system in some implementations may support “write once” programming, preventing tampering. Setting this lock bit instructs the hardware to permanently fix the registers, preventing subsequent writes to those registers, for example the writes which could potentially occur during a security breach.

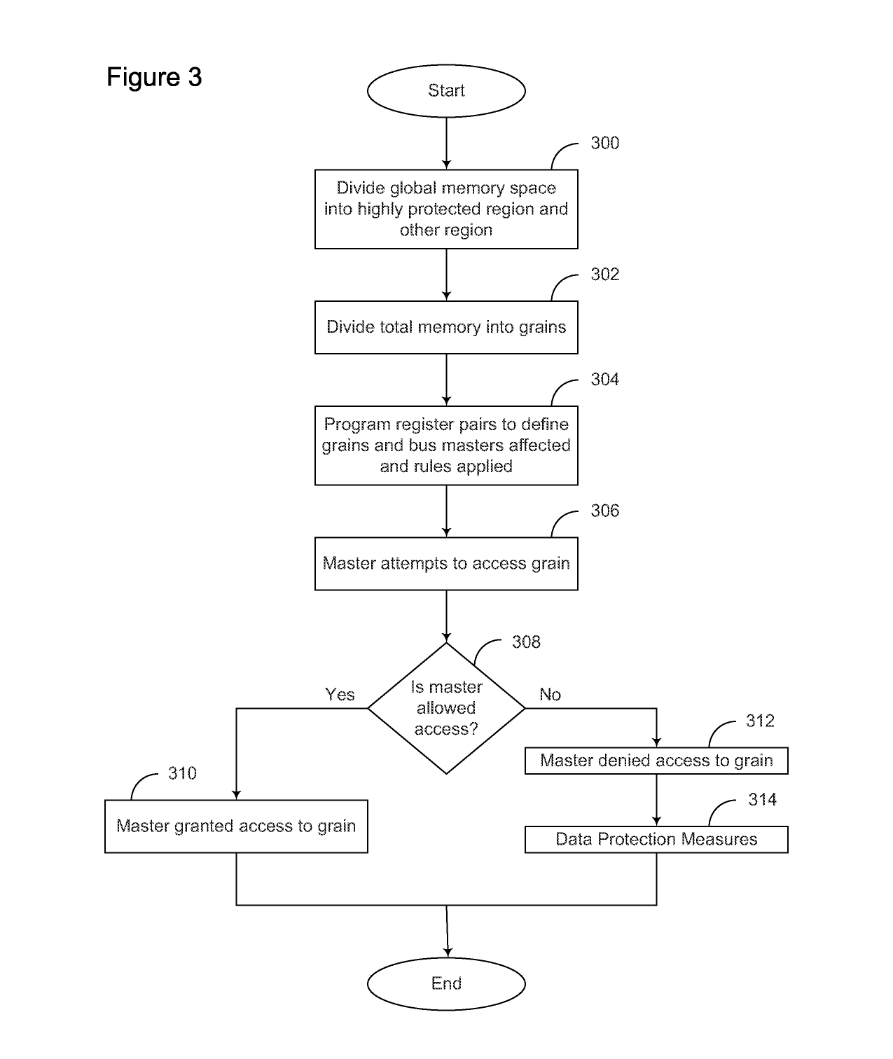

FIG. 3 depicts steps in a method of implementation and use of an exemplary embodiment of a hardware based memory access protection system made in accordance with methods and systems consistent with the present invention. The global memory space is divided into two classes an “other” region and a “highly protected region,” for example Other Memory 108 and Highly Protected Memory 110 of FIG. 1 (step 300). A hardware based memory access protection system made in accordance with methods and systems consistent with the present invention, for example Memory Protection Unit 114 of FIG. 1, specifically targets and protects the highly protected region. The highly protected memory is divided into “grains”, where the size of the grains may be programmable by the user or pre-programmed into the system (step 302). A grain is a fixed size piece of memory defined similarly to the way that modern Memory Management Units (MMUs) divide virtual address space into “pages.” The size of a grain is a function of the total amount of memory space in the highly protected memory, the size of the buffers and memory sub-regions used by the hardware and encryption algorithm and the desire to limit the size of the grain enable bit registers to limit the size of exemplary embodiments, Next, register pairs may be programmed to define the various operations which may be performed by a given bus master on a given grain of memory, for example as described above in relation to Control Register 202 and Grain Enable Bit Register 204 of Register Pair 200 in FIG. 2 (step 304).

Once the register pairs are programmed, the system may be used. First, a given master may attempt to access a memory location (step 306). The system then determines whether the given master is allowed, access to the requested memory location, be it in either in the highly protected memory in one of the grains or in the other memory (step 308), if the given master is allowed to access the given memory location based on the programmed rules, the system grants access to the requested memory location (step 310). However, if the given master is not allowed to access the given memory location based on the programmed rules, the system denies access to the requested memory location (step 312). Finally, where a rule has been violated, the system may apply data protection measures (step 314). These steps taken in the event of the violation of a rule are system and/or application dependent. In some implementations, prevention of data transfer may be accomplished by having the system bus read data multiplexer substitute a default value, for example all zeros, so that the data is not visible. In other implementations comprising no read data multiplexer, for example if the system bus were implemented using “tri-state” logic, the system may implement other methods to prevent data transfer, for example a hardware reset, Still other implementations may presume a tamper event. This presumption of tamper may trigger a system reset, requiring a reboot, or may cause the data in question to be deliberately erased.

1. A method in a data processing system for determining access to grains of memory, comprising:
programming hardware registers with rules to implement access to one or more grains of memory space by one or more masters on a bus;
receiving a request by one of the masters on the bus to access one or more of the grains of memory space;
accessing the programmed hardware registers to determine access to the one or more grains of memory space by the requesting master;
determining, by the hardware registers, access to the one or more grains; and
providing access to the one or more grains of memory space to the requesting master on the bus.

2. The method of claim 1, wherein the hardware registers comprise an address register that determines the area of the memory spaced to be accessed.

3. The method of claim 1, wherein the hardware registers comprise a control register that controls the operation that may be performed on the grain in the memory space.

4. The method of claim 3, wherein the control register permits one or more of operations accessing the memory space comprising: (1) write, (2) read, (3) execute, (4) cache, and (5) buffer.

5. The method of claim 1, wherein the hardware registers define an operation to be performed on the grain in the memory space as one of: (1) an operation that only the requesting master can perform, (2) an allowed operation or (3) a prevented operation.

6. The method of claim 1, further comprising locking the registers so that the hardware registers may no longer be reprogrammed.

7. A data processing system for determining access to grains of memory, comprising:
a memory space comprising the grains of memory;
a bus connected to hardware registers and masters;
one or more masters on the bus configured to:
request access to one or more of the grains of memory space; and
access programmed hardware registers to determine access to the one or more grains of memory space by the requesting master; and
the hardware registers configured to:
be programmed with rules to implement access to the one or more grains of memory space by the one or more masters on a bus; and
receive a request by one of the masters on the bus to access one or more of the grains of memory space;
determine access to the one or more grains; and
provide access to the one or more grains of memory space to the requesting master on the bus.

8. The data processing system of claim 7, wherein the hardware registers comprise an address register that determines the area of the memory spaced to be accessed.

9. The data processing system of claim 7, wherein the hardware registers comprise a control register that controls the operation that may be performed on the grain in the memory space.

10. The data processing system of claim 9, wherein the control register permits one or more of operations accessing the memory space comprising: (1) write, (2) read, (3) execute, (4) cache, and (5) buffer.

11. The data processing system of claim 7, wherein the hardware registers define an operation to be performed on the grain in the memory space as one of: (1) an operation that only the requesting master can perform, (2) an allowed operation or (3) a prevented operation.

12. The data processing system of claim 7, further comprising locking the hardware registers so that the hardware registers may no longer be reprogrammed.
